(19) United States
(12) Patent Application Publication
(10) Pub. No.: US 2012/0110640 A1
(43) Pub. Date: May 3, 2012

(54) METHOD, APPARATUS AND SYSTEM FOR WIRELESS NETWORK AUTHENTICATION THROUGH SOCIAL NETWORKING

(76) Inventors: Loren J. Donelson, San Diego, CA (US); Charles W. Sweet, III, San Diego, CA (US)

(21) Appl. No.: 13/287,931

(22) Filed: Nov. 2, 2011

Related U.S. Application Data
(60) Provisional application No. 61/409,114, filed on Nov. 2, 2010.

(51) Int. Cl. G06F 21/00

(52) U.S. Cl. 726/3

(57) ABSTRACT

One exemplary embodiment includes a method for authenticating a terminal to an access point including: (i) receiving, at a server, network configuration information for an access point associated with a first user from a first terminal; (ii) receiving, at the server, a request for the network configuration information for the access point from a second terminal associated with a second user; (iii) sending a query from the server to a social network requesting information regarding whether the first user and the second user have a virtual trust relationship on the social network; (iv) receiving, from the social network, an indication that the first user and the second user have the virtual trust relationship; and (v) sending the network configuration information from the server to the second terminal.

This application claims priority to and is a U.S. non-provisional patent application of U.S. Provisional Patent Application No. 61/409,114, filed Nov. 2, 2010, entitled “METHOD, APPARATUS AND SYSTEM FOR WIRELESS NETWORK AUTHENTICATION THROUGH SOCIAL NETWORKING,” which application is incorporated herein by reference in its entirety.

### BACKGROUND

1. Field of the Invention

The present invention relates to network authentication. More specifically, in some embodiments, the present invention relates accessing providing network authentication for accessing a secured network.

2. Discussion of the Related Art

In general, a wireless network access point connects user terminals such as laptops or phones to a network. A common example of a network access point is a Wireless Fidelity (“Wi-Fi”) router. Wi-Fi routers commonly use protocols such as IEEE 802.11(a), (b), (g) or (n) as their wireless air interface, although other protocols can be utilized. Often access points encrypt their wireless signals for security purposes. In Wi-Fi, there are two common security methods, i.e., Wired Equivalent Privacy (“WEP”) and Wi-Fi Protected Access (“WPA”). WEP requires the user terminal to configure a 64-bit or 128-bit key and WPA requires a key or passphrase to gain access to the access point. Wi-Fi routers distinguish themselves with their SSID (Service Set Identifier). To access the Wi-Fi router the user configures the access terminal with the network's SSID and WEP key or WPA passphrase depending on the security method in place.

A social network is, for example, a social structure made up of individuals (or organizations) called ‘nodes’, which are tied (connected) by one or more specific types of interdependency, such as friendship, kinship, common interest, financial exchange, dislike, sexual relationships, or relationships of beliefs, knowledge or prestige. One popular example of a social network is Facebook.com. Other examples of social networks are MySpace, Twitter, and Linked-in. At Facebook.com users select or connect to other members who are “friends” which grants these users special privileges. On Linked-in users select or have “connections” to other members. Many social networks have Application Programming Interfaces (APIs) to which third party applications can access some or all of the social networks services programmatically. Facebook supports their “Graph API” as one example of this (http://developers.facebook.com/docs/api). Social Networks typically require users to authenticate with the Social Network to access the associated services. An example of a Social Networking authentication screen is shown in FIG. 1.

### BRIEF DESCRIPTION OF THE DRAWINGS

The above and other aspects, features and advantages of the present invention will be more apparent from the following more particular description thereof, presented in conjunction with the following drawings, wherein:

FIG. 1 illustrates one example of a social networking authentication screen;

FIG. 2 is a system diagram illustrating a system for network security authentication in accordance with one embodiment;

FIG. 3 is a flow diagram illustrating a method of sharing network access configuration information in accordance with one embodiment;

FIG. 4 is a diagram illustrating a screenshot of a Main view of Android application in accordance with one embodiment;

FIG. 5 is a diagram illustrating a screenshot of the Android application Friend view 500 in accordance with one embodiment;

FIG. 6 is a diagram illustrating a screenshot of the Android application Shared Network view 600 in accordance with one embodiment;

FIG. 7 is a diagram illustrating a screenshot of the Android application Configured Network view 700 in accordance with one embodiment;

FIG. 8 is a diagram illustrating a screenshot of a dialog box 800 of the Android application in accordance with one embodiment;

FIG. 9 is a system diagram illustrating a system for network security authentication in accordance with another embodiment;

FIG. 10 is a flow diagram illustrating a method of sharing network access configuration information in accordance with one embodiment; and

FIG. 11 is a diagram illustrating a login screen where a user can log in or log out an application.

Corresponding reference characters (if any) indicate corresponding components throughout the several views of the drawings. Skilled artisans will appreciate that elements in the figures are illustrated for simplicity and clarity and have not necessarily been drawn to scale. For example, the dimensions, sizing, and/or relative placement of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION OF THE DRAWINGS

The following description is not to be taken in a limiting sense, but is made merely for the purpose of describing the general principles of the invention. The scope of the invention should be determined with reference to claims (whether presented now or in the future). The present embodiments address the problems described in the background while also addressing other additional problems as will be seen from the following detailed description.

One embodiment includes a method for authenticating a terminal to an access point including: (i) receiving, at a server, network configuration information for an access point associated with a first user from a first terminal; (ii) receiving, at the server, a request for the network configuration information for the access point from a second terminal associated with a second user; (iii) sending a query from the server to a social network requesting information regarding whether the first user and the second user have a virtual trust relationship on the social network; (iv) receiving, from the social network, an indication that the first user and the second user have the virtual trust relationship; and (v) sending the network configuration information from the server to the second terminal. In one embodiment, the virtual trust relationship includes the first user and the second user being “friends” or “connected” on the social network. In an optional step, once the second terminal receives the network configuration information, the second terminal accesses a network through the access point associated with the first user. In the above example, the first user is, for example, a person or a business.

Another embodiment includes an application for authenticating a terminal to an access point, the application configured to: (i) receive network configuration information for an access point associated with a first user from a first terminal; (ii) receive a request for the network configuration information for the access point from a second terminal associated with a second user; (iii) send a query to a social network requesting information regarding whether the first user and the second user have a virtual trust relationship on the social network; (iv) receive, from the social network, an indication that the first user and the second user have the virtual trust relationship; and (v) send the network configuration information from the server to the second terminal. In one embodiment, the virtual trust relationship includes the first user and the second user being “friends” or “connected” on the social network. In the above example, the first user is, for example, a person or a business.

One alternative embodiment includes a method for authenticating a terminal to an access point including: (i) requesting, from a terminal associated with a first user, network configuration information for an access point associated with a second user; (ii) providing, from the terminal, information indicative of a social network trust relationship between the second user and the first user to a server or an access point; and (iii) receiving, at the terminal, the network configuration information for the access point from the server or the access point the terminal associated with a first user based, at least in part upon providing the information indicative of a social network trust relationship between the second user and the first user. Optionally, the terminal accesses a network through the access point after receiving the network configuration information. In one embodiment, the virtual trust relationship includes the first user and the second user being “friends” or “connected” on the social network. In the above example, the second user is, for example, a person or a business.

In another alternative embodiment, an application for authenticating a terminal to an access point is provided, the application configured to: (i) request, from a terminal associated with a first user, network configuration information for an access point associated with a second user; (ii) provide, from the terminal, information indicative of a social network trust relationship between the second user and the first user to a server or an access point; and (iii) receive, at the terminal, the network configuration information for the access point from the server or the access point the terminal associated with a first user based, at least in part upon providing the information indicative of a social network trust relationship between the second user and the first user. In one embodiment, the virtual trust relationship includes the first user and the second user being “friends” or “connected” on the social network. In the above example, the second user is, for example, a person or a business.

Yet another embodiment includes a method for authenticating a terminal to an access point including: (i) receiving, at an access point associated with a first user, an attempt to connect to the access point from a terminal associated with a second user; (ii) requesting, from the terminal, social network authentication information (e.g., login information); (iii) receiving from the terminal the social network authentication information associated with the second user; (iv) sending the social network authentication information of the second user to a social network; (v) receiving, at the access point, a message from the social network that the social network authentication information has been authenticated by the social network; (vi) receiving, at the access point, a message from the social network that the first user and the second user have a trust relationship (e.g., “friends” or “connected”) on the social network; and (vii) providing access to a network from the access point to the terminal. In the above example, the first user is, for example, a person or a business.

Still another embodiment includes an access point associated with a first user including software loaded on the access point, the software configured to: (i) receive, at the access point associated with a first user, an attempt to connect to the access point from a terminal associated with a second user; (ii) request, from the terminal, social network authentication information (e.g., login information); (iii) receive from the terminal the social network authentication information associated with the second user; (iv) send the social network authentication information of the second user to a social network; (v) receive, at the access point, a message from the social network that the social network authentication information has been authenticated by the social network; (vi) receive, at the access point, a message from the social network that the first user and the second user have a trust relationship (e.g., “friends” or “connected”) on the social network; and (vii) provide access to a network from the access point to the terminal. In the above example, the first user is, for example, a person or a business.

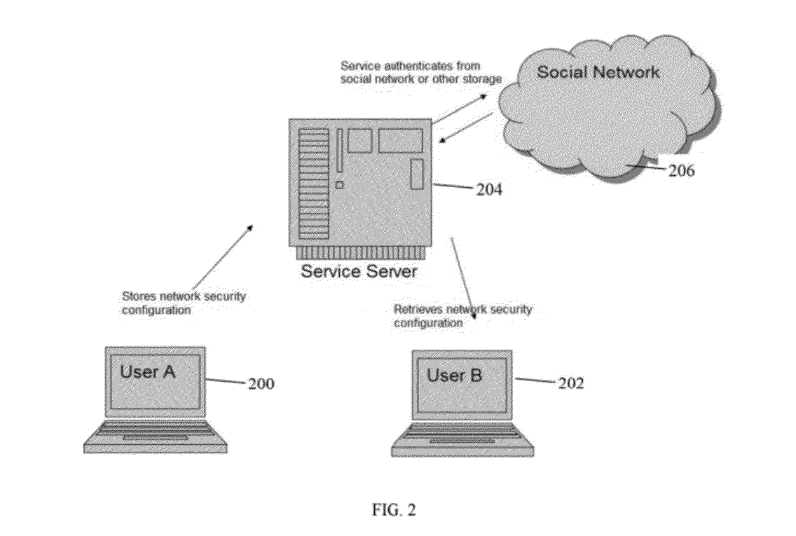

Referring to FIG. 2, a diagram is shown illustrating a system in accordance with one embodiment. Shown is a first terminal 200, a second terminal 202, a server 204 and a social network 206. The first terminal 200 and the second terminal 202 are coupled to the server 204 through a network (e.g., the Internet or other Wide Area Network (WAN)). The server is coupled to the social network through the network.

The first terminal 200 and the second terminal are, for example, a computer, a cell phone, a smart phone, a personal digital assistant (PDA), a tablet computer, or other type of electronic device capable of accessing a network.

In the system illustrated in FIG. 2, the first terminal 200 is being used or is owned by User A and the second terminal 202 is being used or is owned by User B. User A and User B have a virtual trust relationship such as being “friends” or “connections” on a social network. Many of the embodiments described herein will refer to “friends.” However, it should be understood that “connections” or other types of virtual trust relationships may also apply to each embodiment. In the present embodiment, User A and User B use the same service to share their network access point security configuration (also referred to as network configuration information). This service, for example, includes the server 204 which performs the coordination functionality of this service allowing users to share their network authentication with authorized users (e.g., “friends” on a social network or other people with a trust relationship). The server 204 is accessible via common networking techniques and is connected to a network (e.g., the Internet).

In the embodiment shown, the server communicates with the social network 206 for authentication of users to a secured network access point. The server optionally uses a RESTful (Representational State Transfer) interface as its communication technique, although other techniques are used in alternative embodiments. The service provided by the server 206 allows users who have a virtual trust relationship (e.g., “friends” on a social network) to access each other's secured network access points. To facilitate access to the secured network access points, a user (e.g., User A and User B) stores their network security configuration on the server or in a database associated with the server. Later, when the user's network security configuration is requested from the server, the software on the server, for example, queries the database to retrieve the security configuration.

In accordance with some embodiments, an access point is, for example, any device which provides networked services. For example, a router or wireless router (e.g., Wi-Fi router) is an access point to the Internet. Smart-phones can provide Wi-Fi access to the Internet using what is known as “Wi-Fi tethering.” Other devices can also function as network access points.

In accordance with the present embodiments, a terminal (e.g., the first terminal 200 and the second terminal 202) is any device which connects to an access point via networking techniques and/or protocols. An example of a terminal is a smart-phone with Wi-Fi capabilities. Another example is a laptop or tablet computer with Wi-Fi capabilities. Other examples are Wi-Fi phones which use VOIP over Wi-Fi for telephony or the examples provided above.

In operation, when User A wants to make available their network access points to others with a virtual trust relationship (e.g., their “friends” on a social network) they share their network security configuration with the Service. The network security configuration can be shared in a number of ways in accordance with various embodiments. In one embodiment, User A installs software on the first terminal 200 which is configured to work with the User's access point (not show). The installed software, which is designed to be used with the service, shares the network security configuration with the service. Alternatively, User A shares their security configuration with the service by navigating to the Service's web site and entering the security information manually through the web site. For example, in operation, the first terminal 200 stores network security configuration from User A's access point. The network security configuration is then sent to the server 204 through the network and stored at a database of the server (or database coupled to the server).

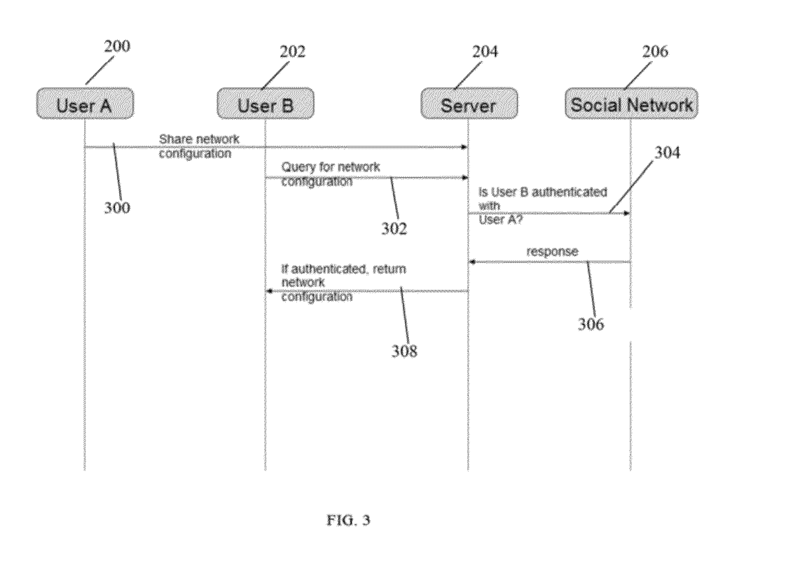

Once User A has shared its network security configuration with the service, it is potentially available to other users having a trust relationship with User A (e.g., “friends”). User B, who has a virtual trust relationship with User B, can then access User A's network by installing software designed to use the service on the second terminal 202. The software queries the server 204 and retrieves the security configuration for User A's network access point. Next, the software configures the network settings on User B's access terminal to connect to User A's access point. (As described in FIG. 3, before the server configures User B's access terminal, it verifies User A and User B have a virtual trust relationship.) Once successfully configured, User B can access the Internet through User A's access point.

Referring to FIG. 3, a diagram is shown illustrating a method of sharing a network securing configuration in accordance with one embodiment. In one embodiment, the method described in FIG. 3 is implemented on the system shown in FIG. 2.

The first terminal 200 is being used or is owned by User A. User A shares their network security configuration with other users (e.g., User B) to which User A has a virtual trust relationship (e.g., “friends” on one or more of their social networks). The second terminal is being used or, for example, is owned by User B. User B seeks to gain access to User A's network through User A's access point (not shown). The server 204 is accessible over a network (e.g., the Internet) and is configured to share the network security information after authentication of User B. The social network 206 is a social networking service which provides, for example, the virtual trust relationship between User A and User B.

In operation, in step 300, the first terminal 200 shares its access point's network security configuration with the server 204. User B wishes to access User A's secured access point. Therefore, at step 302, the second terminal 202 queries the server 204 requesting User A's network security configuration (also referred to herein as the security configuration). The server 204, in turn, at step 306, queries the social network 206 to verify User A is, for example, “friends” with User B. In step 308, the social network replies to the query with a list of User A's “friends.” Alternatively, the social network could reply only with User B, if User B is friends with User A. Still alternatively, the social network can provide verification that User B is a friend of User A. In step 310, once the server verifies that User A is “friends” with User B, the network security configuration is provided to the second terminal 202. The second terminal 204, (i.e., User B's access terminal) and User B can now access User A's network through User A's network access point.

Without referring to any specific figure, in one exemplary embodiment, User A and User B share their network security information (e.g., network keys) by both participating in a network based service which has a server accessible over the Internet. The server stores the network security information in a database. The server also controls which users gain access to other user's network security configurations. For User B to gain access to User A's secured network access point, User B's device (i.e., a terminal) queries the server for a list of available networks and their associated keys. The server first retrieves the list of User B's “friends” from the social network and the queries the server's database to find which “friends” have shared their networks and associated keys. This list of network ID and associated key pairs is then returned to User B. If User B is in User A's list of “friends,” and User A previously shared its network security information with the server, then User A's network and associated key is included in the list returned to User B. User B will then be able to connect to User A's network access point.

In another exemplary embodiment, User A and User B share their network keys by participating in a network based service which has a server that is accessible over a network (e.g., the Internet). The server stores the network security information in a database. The server controls which users gain access to other user's security configurations. For User B to gain access to User A's secured access point, User B's device queries the social network for a list of User B's “friends.” User B's device then queries the server for each of User B's “friends” network security configurations (e.g., a SSID & WEP key pair). For each of User B's “friends,” if the “friend” had previously shared its network security configuration (e.g., was also a user of the server or a member of the service), the “friend's” network security configuration is returned to User B's device (i.e., terminal). If User A is one of User B's “friends” who had previously shared their network security information with the server, User A's network and key is available to User B. After User B's device receives the network security information, the device is configured so that User B can connect to User A's network.

The service described in the above examples, which allows the sharing of the network security configurations, can optionally include another layer of filtering on who gains access to each other's network security configurations. For example, the service's website or access terminal software provides additional functionality to select a subset of the user's “friends” with which to share their network security configurations. For example, in this embodiment, in order for User B to gain access User A's network security information, the following conditions would need to be met:
User B is a “friend” of User A.
User A has shared its network security configuration with the server.
User B has access to the service either by installing software, registering with the service, both, or otherwise.
User A is specifically designated to be allowed User B access to User A's shared network security configuration.

For example, in this embodiment, User A may have many “friends” on its social network. However, User A only wants its family members or other subset of its “friends” to have access to its network security configuration. Therefore, User A can designate on those subset of its “friends” that are allowed to have access. The server determines whether User B is part of the subset of “friends” by, for example, a simple additional logic check. In one example, on facebook.com, there is an application that is used to keep track of which “friends” are family members. The server could query the application or User A's profile to determine the family members.

In one embodiment, a service which enables social networking “friends” to share their access point's network security configurations includes an Android application and a Google AppEngine-based web-service. The Android application allows users to share their network security configurations and connect to their Facebook “friends” access points. The AppEngine-based web-service uses a secure, RESTful protocol which enables access terminals to programmatically share their network security configurations. If any of the access terminal's owner's Facebook “friends” have shared their network security configurations with the Application Engine-based web-service, the configurations can be retrieved and configured on the access terminal. Applications running on other operating systems are used in alternative embodiments. For example, an application for a Windows laptop, a Macbook, iPhone, or Windows Mobile Phone is used in alternative embodiments, however, will not be described in greater detail here.

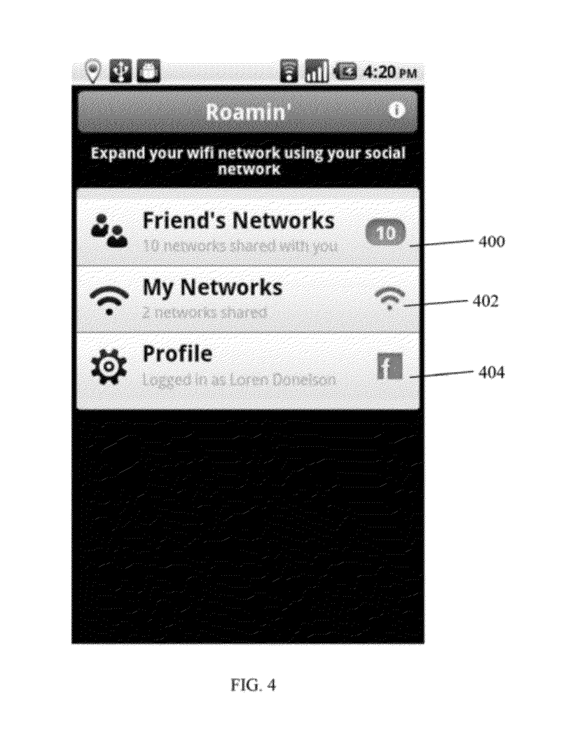

FIGS. 4-8 and FIG. 11 are diagrams illustrating various screen shots of the Android application described above. Again, this specific embodiment is for illustrational purposes only and other applications for other operating systems or platforms are used in alternative embodiments. For example, a stand-alone Windows application or a browser plug-in is used in an alternative embodiment. Additionally, it should be understood that the functionality of each user interface screen is for illustrational purposes only. Some of the functions may not be necessary in some embodiments. Additionally, some of the functionality provided can alternatively be provided through a separate interface screen (also referred to as a view). That is, for example, the functionality described with reference to any of FIGS. 4-8 and FIG. 11 can be included on other interface screens in alternative embodiments.

In the embodiments described in FIGS. 4-8 and FIG. 11, the Android application is running on a smart phone (i.e., on exemplary terminal). Other types of terminals are utilized in alternative embodiments.

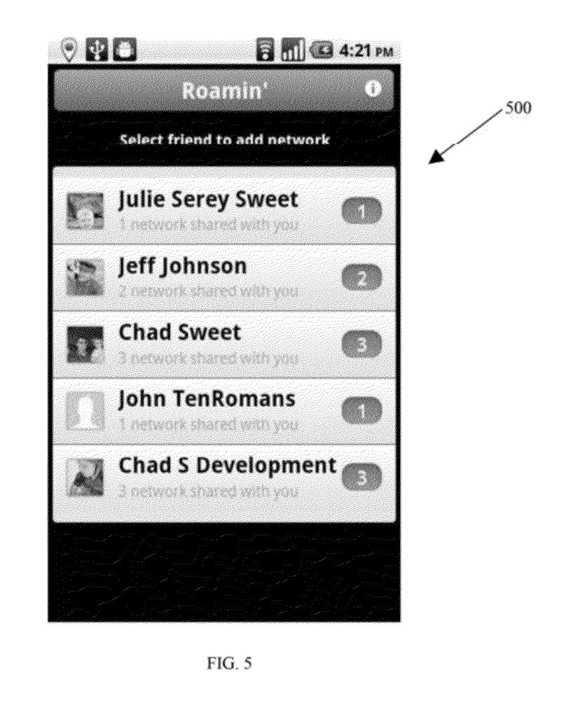

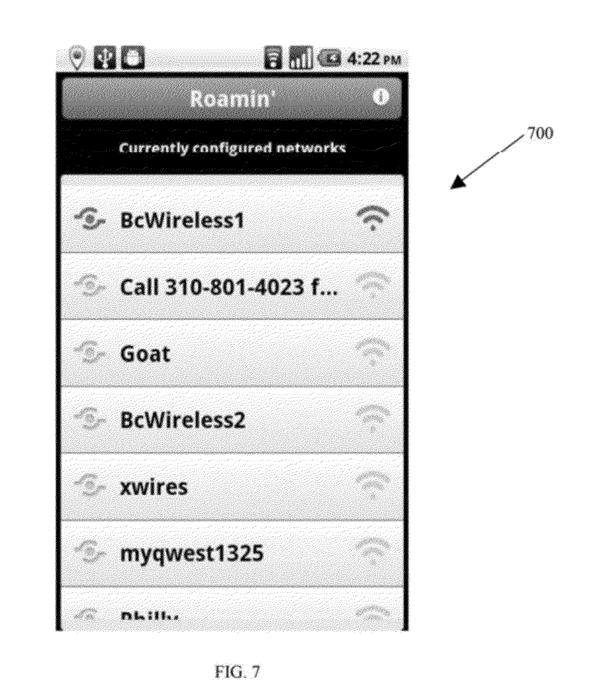

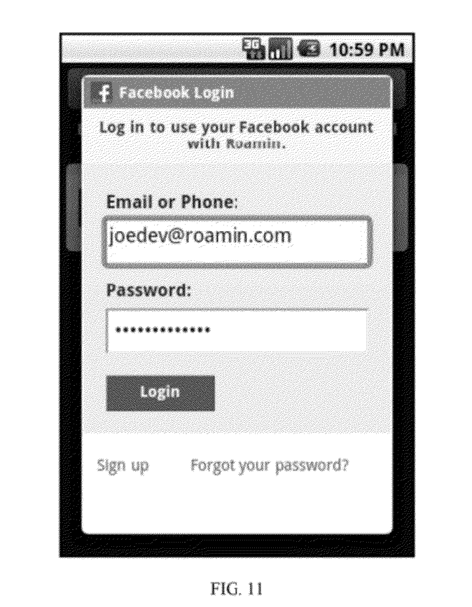

Referring now to FIG. 4, a screenshot is shown of the Android application Main view in accordance with one embodiment. The Main view appears when a user of the application first opens or launches the Android application. The main view has three general areas of functionality in accordance with this exemplary embodiment. The “Friend's Networks” area 400 enumerates the cumulative number of networks shared by the application user's “friends.” In this exemplary screenshot, the notification indicates that 10 networks have been shared with the user. If the user touches in area 400 with the smart phone's touchscreen (or otherwise selects the Friend's Networks area 400) the application displays a list of the user's “friends” which are also users of the service (as seen and described in FIG. 5 below). The second area 402, “My Networks” area 402, enumerates all of the networks which are configured for the device. Only the networks with the blue icon on the left have been shared with friends. In the embodiment shown, the user has access to a total of 2 networks. The blue wireless indicator in the My Networks area 402 indicates that the user is connected to one of the 2 networks which they have shared. If the user touches in this area 402 with the smart phone's touchscreen (or otherwise selects the area 402) the Android application then displays a list of the user's networks which are shared (shown and described below with reference to FIG. 7). The third area 404 is the “Profile” area 404. In this embodiment, the Profile area 404 indicates that the user has authenticated the application with Facebook. If the user touches in this area with the smart phone's touchscreen (or the user otherwise selects the Profile area 404 if the smart phone does not have a touch screen feature), the application displays the Profile view where they could log in or log out the application with Facebook, such as shown and described below with reference to FIG. 11.

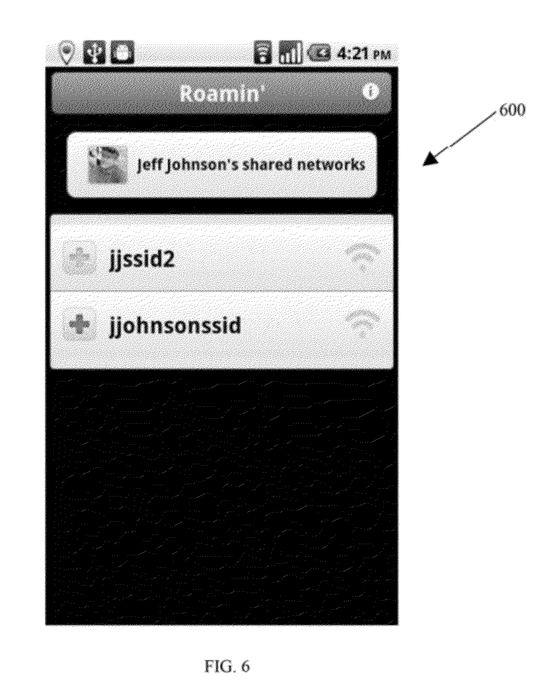

Referring next to FIG. 5, a screenshot is shown of the Android application Friend view 500 in accordance with one embodiment. The Friend View 500 lists the user's “friends” which are also configured with the service. Each row area represents one of the user's “friends” and provides status information associated with the “friend.” On the left is the “friend's” Facebook profile picture. The large font row is the “friend's” profile name. The smaller font lists the number of networks the “friend” has shared. The blue number on the right also represents the number of networks the “friend” has shared. If the user touches one of the “friends” areas with the smart phone's touchscreen (or otherwise selects the area) the application displays more information about the “friend's” shared networks (shown and described below with reference to FIG. 6).

Referring now to FIG. 6, a screenshot is shown of the Android application Shared Network view 600 in accordance with one embodiment. The Shared Network view 600 lists one of the user's “friend's” shared networks. In the embodiment shown, “JeffJohnson” has shared two Wi-Fi network configurations: jjssid2 and jjohnsonssid. On the left of the network's name is a blue cross which indicates whether the network configuration has been added to the user's terminal (e.g., the Android Smart Phone) or whether it has not been added. Namely, if the blue cross is present, it has been added to the User's terminal. On the right side of the network's name is an indication of whether the network is within wireless connectivity range. (The embodiments described herein use the example of wireless networks. However, other networks such as a wired network are used in other embodiments.) In the embodiment shown, there are no networks in range of the device. If the user selects one of the networks with the smart phone's touchscreen (or otherwise selects one of the networks) the application displays options for the user to add the network, if not currently configured, or remove that network, if currently configured, from the user's access terminal.

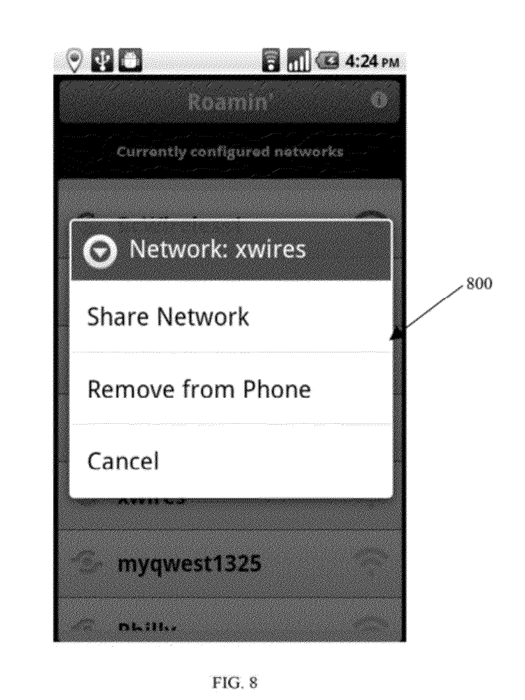

Referring now to FIG. 7, a screenshot is shown of the Android application Configured Network view 700 in accordance with one embodiment. The Configured Network view 700 lists all of the user's configured Wi-Fi networks (or other networks, wireless, wired or otherwise). In the present embodiment, each row of information shows: (i) the Wi-Fi network's SSID, (ii) whether the network is shared, and (iii) whether the network is connected. In this figure, the Wi-Fi network with BcWireless1 as its SSID is shared with the user's Facebook “friends” (as indicated by the blue icon to the left of the SSID) and the user's Android smart-phone is connected to the network (as indicated by the blue icon to the right of the SSID). If the user selects one of the networks with the smart phone's touchscreen (or otherwise) the application allows the user to: (i) share the network configuration, (ii) un-share the network configuration, or (iii) remove the network configuration from the device. An example of these three options is illustrated in FIG. 8 described below.

Referring now to FIG. 8, a screenshot of a dialog box 800 of the Android application is shown in accordance with one embodiment. The dialog box 800 appears when the user selects one of its networks from the list illustrated in FIG. 7 which has not been shared. If the user selects the “Share Network” option, the network which had been selected is shared via the service. This sharing process involves, for example, sending the network configuration for the network to the server, which stores the configuration in its database. If the user selects “Remove from Phone” the network configuration would be deleted from the Android smart-phone's list of configured networks. The user would then be presented with an option to un-share the network from the service.

If the user selects one of its shared networks from the list illustrated in FIG. 7, instead of providing the “Share Network” option, the dialog box 800 will include a “Un-Share Network” option. This un-sharing process involves, for example, sending a request to the server to delete the specified network configuration from the server, which removes the configuration from its database.

In accordance with one embodiment, one use for the described system is for users to easily connect to their “friends” secured networks when they visit their “friend's” houses, apartments or workplace. Instead of needing to type in a difficult to remember Wi-Fi passkey, the application provides an easy graphical entry method. Namely, as shown in FIG. 4, the user selects the “Friend's Networks” item from the list of available networks. The list includes the user's friends as shown in FIG. 5. The user selects the friend whose house the user is currently visiting. Next, the interface displays the friend's networks as shown in FIG. 6. The user then selects the user's network and adds the network by pressing the “Add Network” option from the dialog. Following addition of the network, the user is able to access the Internet through the friend's access point.

In another embodiment, another use of the described system helps a business to gain “friends” for their social network advertising. For instance, many businesses (such as a coffee shop or book store) have a secured Wi-Fi network available for their customers to use. In operation, the network security configuration for the business' network is shared with the described service. The network security configuration is shared, in one embodiment, through the service's web-based interface or by the proprietor or manager of the business using the service's client application. Next, as one example, to gain access to the secured Wi-Fi network, customers would “friend” the business on Facebook (or “connect” on Linked-in). Next, the customer using the service's client application (described in FIGS. 4-8 and FIG. 11) can easily access the business' Wi-Fi network. Advantageously, this would provide the business with information about its customers through the information available on Facebook (or other social network). This would also, for example, allow the business to maintain an advertising and promotion communications channel with its customers.

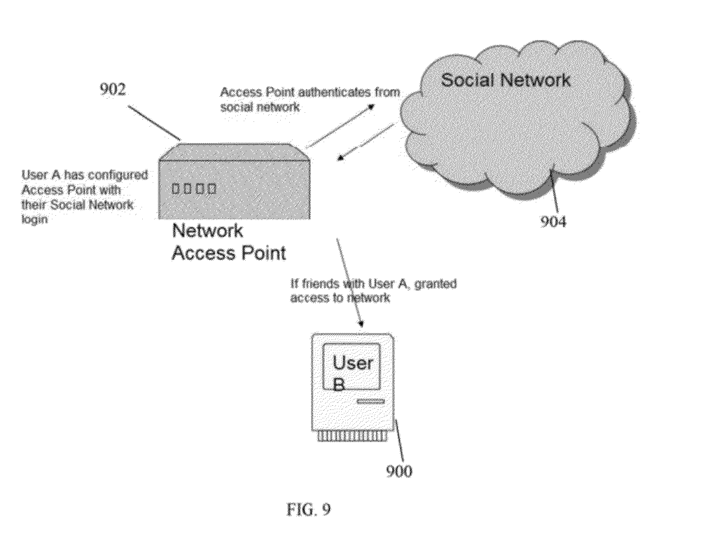

Referring next to FIG. 9, a system diagram is shown illustrating a system for network security authentication in accordance with another embodiment. Shown is a terminal 900, a network access point 902, and a social network 904.

In the shown embodiment, the network access point 902 can be any device which provides networked services. For example: (i) a Wi-Fi router is an access point to the Internet; and (ii) Smart-phones can provide Wi-Fi access to the Internet using what is known as Wi-Fi tethering. The terminal 900, in accordance with one embodiment, is any device which connects to an access point via common networking techniques and protocols or otherwise. One example of the terminal 900 is a smart-phone with Wi-Fi capabilities or other network access capabilities. Another example is a laptop or tablet computer with Wi-Fi capabilities. Yet another example is a Wi-Fi phone which uses VOIP over Wi-Fi for telephony.

In the system illustrated in FIG. 9, the network access point 902 (e.g., a Wi-Fi router) has the ability to authenticate users using a social network's “friends” list. For example, User A owns the access point 902 and has configured the access point 902 with User A's social network authentication (e.g., his login information to Facebook). User A has configured the access point 902 to allow any of User A's “friends” on the social network to gain access User A's access point 902. In this specific embodiment, the Social Network 904 represents the Social Network 904 site's programming interface which allows programmatic access to user's “friends” information along with other associated services. The access point 902 has a network connection to the Social Network's programming interface and is able to query User A's “friends” list.

In this embodiment, the access point 902 is configured to challenge any unauthorized user with a Social Networking login. (Alternatively, users could be authorized apriori using a number of different methods such as MAC address filtering or by entering a username and password.) In this regard, for purposes of the present example, User B is currently unauthorized and wishes to connect to User A's network using User A's access point. When User B's device attempts to connect to the access point, the access point will request or “challenge’ User B for a social network login. This request is presented to User B's device as a web page, dialog box, or otherwise. For example, when User B opens a web browser (e.g., Microsoft Internet Explorer, Google Chrome, or otherwise) the Social Network's authentication screen is presented. User B then enters log in information (i.e., his/her social network authentication information) into the web browser running on the device. If User B successfully logs in, the network access device 902 will query the social network 904 to determine if User B is “friends” with User A (the access point owner). If so, the access point will allow User B network access through the network access point 902.

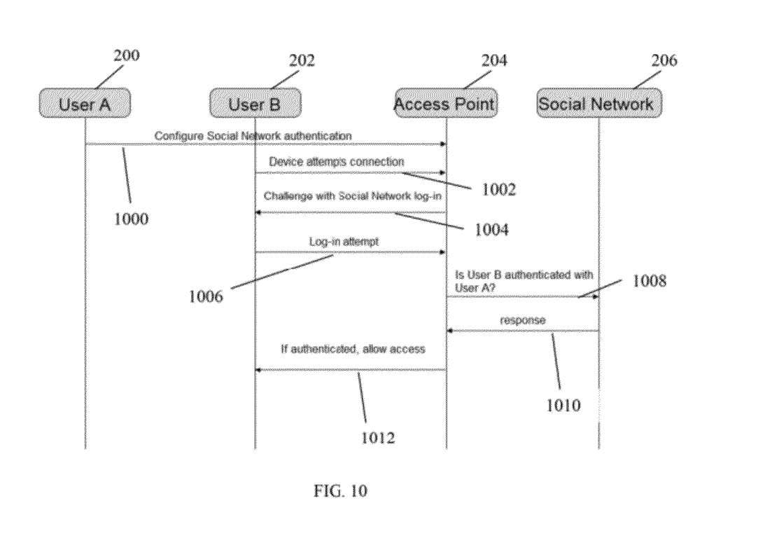

Referring now to FIG. 10, a flow diagram is shown illustrating a method of sharing network access configuration information in accordance with one embodiment.

In one embodiment, FIG. 10 illustrates a process flow for the system shown in FIG. 9. However, the process described with reference to FIG. 10 may be implemented in other systems. In the example shown, User A is the owner (or somehow controls) the access point 204. User A desires to share the access point 204 with his social network “friends.” User B is a “friend” of User A and wishes to access User A's network through User A's access point. In operation, software on the Access Point 204 is configured to communicate with the Social Network 206. Although not shown in the flow diagram, User A first configures the Access Point 204 to allow for network authentication through a trust relationship on a social network.

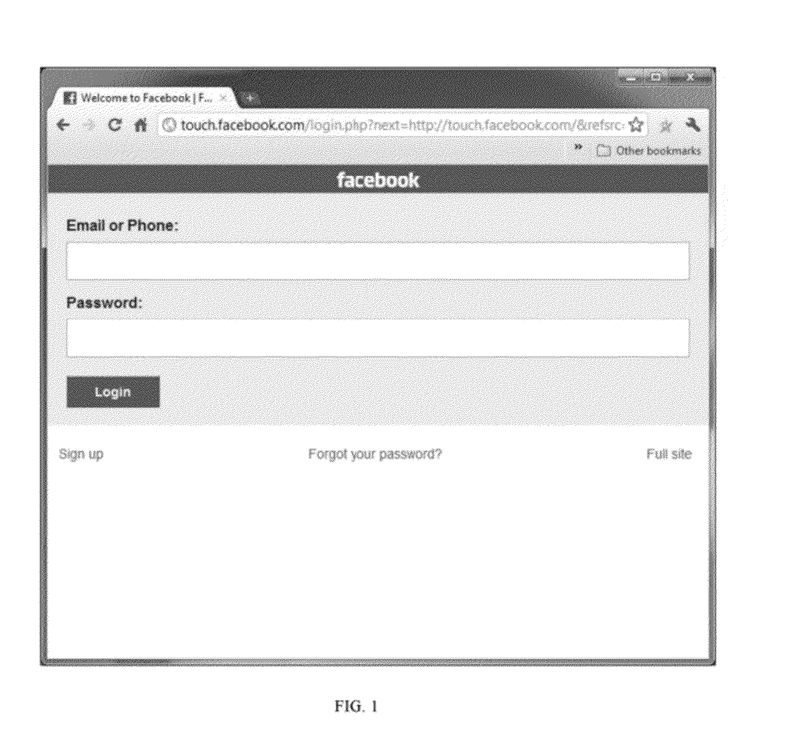

Next, in step 1000, User A configures the Access Point 204 with User A's social network log in using User A's terminal 200. Next, in step 1002, User B's access terminal 202 attempts to access User A's network through User A's access point 202 using, for example, a web browser on User B's access terminal 202. The access point 204 returns, for example, a web page with a social network log in form (such as shown in FIG. 1). In step 1004, User B, through its terminal 202, enters their social network log in information and attempts to authenticate in step 1006. In step 1008, the Access Point 204 passes that authentication information (e.g., login information) to the Social Network 206. Next, in step 1010, the social network 206 returns an indication to the access point 204 of whether User B successfully logged in to the social network 206 and if User B is “friends” with User A. Optionally, the social network 206 returns an indication of whether User B is “friends” with User A in a separate message to the access point 204. In step 1012, if User B successfully logs in to the social network 206 and is “friends” with User A, then User B is provided access to User A's network through User A's access point 204.

In some embodiments, the network access point 204 allows its owner to share its network access with its “friends” by providing social networking authentication software on the access point 204. When the owner of the access point 204 configures the network, the access point's configuration includes the owner's authentication for the supported social network. Once configured, if an unauthorized user accesses the network through the access point 204, for example, using a web browser on a terminal, the user is presented with a social networking authentication screen. One example of a social networking authentication screen is the login widget associated with “Facebook Connect” such as shown in FIG. 1. After the user enters its social network login credentials (e.g., user name and password) through the authentication screen, the social network login credentials are provided to the social network's authentication service. Facebook, for example, uses OAuth 2.0 to allow third party applications to authenticate to its service. Once the user has successfully logged in to Facebook (or other social network web-site), the access point queries the service to determine if the user is a member of the “friends” list of the owner of the access point 204. If the user is a member of the owner's “friends” list, the user can access the Internet through the access point 204. Optionally, the user's authentication status is tracked through the user's MAC address recorded locally to the access point 204 to accelerate subsequent authentication attempts.

In another embodiment, the network access point allows its owner to share its network access with its “friends” by providing social networking authentication software on access point 204. In this embodiment, when the owner of the access point 204 configures the network, the access point's configuration includes the owner's authentication for the supported social network 206. When the owner logs into the supported social network 206 through the access point 204, the access point 204 presents the owner with a list of “friends.” The owner of the access point 204 then selects which “friends” to allow access the owner's network through the owner's access point 204. Once configured, if an unauthorized user accesses the network with, for example, their web browser, the unauthorized user is presented with a social networking authentication screen (such as in FIG. 1). One example of a social networking authentication screen is the login widget associated with Facebook Connect. After the user inputs his login information into the authentication screen on the accessing user's terminal, a query is sent to the social network's authentication service. Facebook, for example, uses OAuth 2.0 to allow third party applications to authenticate to its service. Once the user is successfully logged in, the access point 204 queries the service to see if the authenticating user is a member of the owner's “friends” list. If the user is a member of the owner's “friends” list and is also one of the “friends” that the owner previously selected the user as one of the “friends” that will have access to the owner's network through the access point 204, then the user will be able to access the Internet through the access point 204. Optionally, the user's authentication status is tracked through the user's MAC address recorded locally to the access point 204 to accelerate subsequent authentication attempts.

While the invention herein disclosed has been described by means of specific embodiments and applications thereof, other modifications, variations, and arrangements of the present invention may be made in accordance with the above teachings other than as specifically described to practice the invention.

We claim:

1. A method for authenticating a terminal to an access point including:
(i) receiving, at a server, network configuration information for an access point associated with a first user from a first terminal;
(ii) receiving, at the server, a request for the network configuration information for the access point from a second terminal associated with a second user;
(iii) sending a query from the server requesting information regarding whether the first user and the second user have a virtual trust relationship on a social network;
(iv) receiving, at the server, an indication that the first user and the second user have the virtual trust relationship; and
(v) sending the network configuration information from the server to the second terminal.

2. The method of claim 1 wherein the virtual trust relationship includes the first user and the second user being “friends” or “connected” on the social network.

3. The method of claim 1 further comprising accessing from the second terminal a network through the access point associated with the first user after the second terminal receives the network configuration information.

4. The method of claim 1 wherein the first user is a person or a business.

5. An apparatus for authenticating a terminal to an access point, the apparatus configured to:
(i) receive network configuration information for an access point associated with a first user from a first terminal;
(ii) receive a request for the network configuration information for the access point from a second terminal associated with a second user;
(iii) send a query requesting information regarding whether the first user and the second user have a virtual trust relationship on a social network;
(iv) receive an indication that the first user and the second user have the virtual trust relationship; and
(v) send the network configuration information from the server to the second terminal.

6. The apparatus of claim 5 wherein the virtual trust relationship includes the first user and the second user being “friends” or “connected” on the social network.

7. The apparatus of claim 5 wherein the first user is a person or a business.

8. A method for authenticating a terminal to an access point including:
(i) requesting, from a terminal associated with a first user, network configuration information for an access point associated with a second user;
(ii) providing, from the terminal associated with the first user, information indicative of a social network trust relationship between the second user and the first user to a server or an access point; and
(iii) receiving, at the terminal associated with the first user, the network configuration information for the access point from the server or the access point associated with the second user based, at least in part, upon providing the information indicative of a social network trust relationship between the second user and the first user.

9. The method of claim 8 further comprising accessing, from the terminal associated with the first user, a network through the access point after receiving the network configuration information.

10. The method of claim 8 wherein the virtual trust relationship includes the first user and the second user being “friends” or “connected” on the social network.

11. The method of claim 8 wherein the second user is a person or a business.

12. An apparatus for authenticating a terminal to an access point is provided, the apparatus configured to:
(i) request, from a terminal associated with a first user, network configuration information for an access point associated with a second user;
(ii) provide, from the terminal associated with the first user, information indicative of a social network trust relationship between the second user and the first user to a server or an access point; and
(iii) receive, at the terminal associated with the first user, the network configuration information for the access point from the server or the access point associated with the second user based, at least in part, upon providing the information indicative of a social network trust relationship between the second user and the first user.

13. The apparatus of claim 12 further configured to access, from the terminal associated with the first user, a network through the access point after receiving the network configuration information.

14. The apparatus of claim 12 wherein the virtual trust relationship includes the first user and the second user being “friends” or “connected” on the social network.

15. The apparatus of claim 12 wherein the second user is a person or a business.

16. A method for authenticating a terminal to an access point including:
(i) receiving, at an access point associated with a first user, an attempt to connect to the access point from a terminal associated with a second user;
(ii) requesting, from the terminal, social network authentication information;
(iii) receiving from the terminal the social network authentication information associated with the second user;
(iv) sending the social network authentication information of the second user to a social network;
(v) receiving, at the access point, a message from the social network that the social network authentication information has been authenticated by the social network;
(vi) receiving, at the access point, a message from the social network that the first user and the second user have a trust relationship on the social network; and
(vii) providing access to a network from the access point to the terminal.

17. An access point associated with a first user including software loaded on the access point, the software configured to:
(i) receive, at the access point associated with a first user, an attempt to connect to the access point from a terminal associated with a second user;
(ii) request, from the terminal, social network authentication information;
(iii) receive from the terminal the social network authentication information associated with the second user;
(iv) send the social network authentication information of the second user to a social network;
(v) receive, at the access point, a message from the social network that the social network authentication information has been authenticated by the social network;
(vi) receive, at the access point, a message from the social network that the first user and the second user have a trust relationship on the social network; and
(vii) provide access to a network from the access point to the terminal.
